(19) United States
(12) Patent Application Publication
(10) Pub. No.: US 2025/0388164 A1
(43) Pub. Date: Dec. 25, 2025

(54) EXPANDABLE SHELTER

(71) Applicant: GravitySlide Inc., Hamilton (CA)

(72) Inventors: Ben Fisher, Hamilton (CA); Dave Smith, Hamilton (CA)

(21) Appl. No.: 18/726,515

(22) PCT Filed: Jun. 28, 2024
(86) PCT No.: PCT/CA2024/050876

§ 371 Date: Jul. 3, 2024

Related U.S. Application Data
(60) Provisional application No. 63/556,016, filed on Feb. 21, 2024.
(60) Provisional application No. 63/654,398, filed on May 31, 2024.

(51) Int. Cl. B60P 3/34

(52) U.S. Cl. CPC B60P 3/34

(57) ABSTRACT

An apparatus for use with a road transportable chassis comprises a body and a pair of shells. The body is connected in use to the chassis and defines a floor and a ceiling disposed in stacked spaced relation, the floor being horizontal and above the chassis. Each shell comprises: a floor and a ceiling disposed in stacked spaced relation; and a wall from which the floor and ceiling protrude. The shells are moveable between: a collapsed position, wherein the shells are relatively proximal, the walls are disposed in flanking relation to the body, the ceilings of the shells overly the ceiling of the body and the floors of the shells overly the body floor; and an expanded position, wherein the shells are relatively distal, the ceilings of the shells define extensions of the ceiling of the body and the floors of the shells define extensions of the body floor.

### FIELD

The invention relates to the field of recreational vehicles.

### BACKGROUND

Known recreational vehicles suffer from a disadvantageous ratio of comfort to cost.

### SUMMARY OF THE INVENTION

Forming one aspect of the invention is apparatus comprising: a chassis, a body and a pair of shells. The chassis is wheeled. The body is mounted to the chassis, defines a floor and a ceiling disposed in stacked spaced relation to one another, is disposed above the chassis and is horizontal. Each shell comprises: a floor and a ceiling disposed in stacked spaced relation to one another; and a wall from which the floor and ceiling protrude. The shells are mounted for movement between a collapsed position and an expanded position. In the collapsed position, the shells are relatively proximal to one another, the walls are disposed in flanking relation to the body, the ceilings of the shells overly the ceiling of the body and the floors of the shells overly the floor of the body. In the expanded position, the shells are relatively distal to one another, the ceilings of the shells define extensions of the ceiling of the body and the floors of the shells define extensions of the floor of the body.

Forming another aspect of the invention is a bearing arrangement by which the shells can be mounted to provide for said movement between the collapsed and expanded configuration.

The bearing arrangement comprises a pair of bearings for each shell, the bearings of the pair being spaced apart from one another lengthwise of the dwelling and each comprising: a track fixedly mounted to the chassis; a roller rotatably mounted to the chassis; a roller disposed in the track of the chassis to be guided thereby for movement and rotatably mounted to the shell by means of a lever arm; and a track fixedly mounted to the shell and in receipt of the roller of the chassis for guided movement thereof.

The tracks and rollers are configured such that: as the shells initially separate from the collapsed position, their inner edges lift and outer edges drop; as the shells reach the expanded configuration, their inner edges drop and outer edges lift; as the shells initially move from the expanded configuration towards the collapsed configuration, their inner edges lift and outer edges drop; and as the shells reach the collapsed configuration, their inner edges drop and outer edges lift.

According to aspects of the invention:
the apparatus can further comprise: a carriage mounted in use to a wall for reciprocating movement between a raised position adjacent the roof and a lowered position distal to the roof, the raised position being spaced from the lowered position along an axis which is substantially vertical when the dwelling is level; and a platform pivotally mounted to the carriage for movement between a raised position, whereat the platform is substantially parallel to the wall, and a lowered position, whereat, when the dwelling is level, the platform is level.
the shells can be movable between the collapsed position and the expanded position only when the platform is at the raised position and beneath the roof; and
when the shells are in the collapsed position, the platform can be at the raised position, beneath the roof and disposed between the wall and the shells.

Forming another aspect of the invention is apparatus for use with a dwelling adapted for road transport, the dwelling having a roof and a wall extending to the roof, the apparatus comprising:
a carriage mounted in use to the wall for reciprocating movement between a raised position adjacent the roof and a lowered position distal to the roof, the raised position being spaced from the lowered position along an axis which is substantially vertical when the dwelling is level; and
a platform pivotally mounted to the carriage for movement between a raised position, whereat the platform is substantially parallel to the wall, and a lowered position, whereat, when the dwelling is level, the platform is level.

According to another aspect, the platform can further be pivotable to a loading position, whereat the platform extends downwardly from the carriage when the dwelling is level.

According to other aspects: the platform can be a bi-fold ramp; the platform can define a horizontal surface when the dwelling is level and the platform is folded upon itself, and can define a ramp which extends to the ground when the carriage is at the lowered position, the platforming is at the loading position and unfolded.

According to another aspect, the platform can have a surface which is substantially coplanar and contiguous with the roof when at the raised position.

Forming another aspect of the invention is apparatus for use with a wheel-mounted dwelling having a floor and a design bottom, the design bottom being defined by the flattened surface of the wheels when the wheel-mounted dwelling is on a horizontal surface, the apparatus comprising: a level coupled in use to the dwelling; a plurality of extendable legs, each leg having a known stroke, the plurality of legs being connected in use to the dwelling in supporting relation and at known positions relative to the dwelling; a sensor arrangement for determining the lift available at each leg; a computing facility adapted to calculate, utilizing the sensor arrangement, the levels, the position of the legs relative to the dwelling and the position of the dwelling relative to the wheels, whether the legs have sufficient lift to level and stabilize the dwelling; and an actuator adapted to extend the legs to level and stabilize the dwelling when the legs have sufficient lift available.

According to another aspect, the computing facility can be adapted to generate one or both of: (i) an indication that the legs have sufficient lift to level and stabilize the vehicle; and (ii) an indication that the legs do not have sufficient lift to level and stabilize the vehicle.

According to another aspect, the computing facility can be adapted to generate one or more of:
(i) an indication that the legs have sufficient lift to level and stabilize the vehicle;
(ii) an indication that the legs do not have sufficient lift to level and stabilize the vehicle; and
(iii) an indication as to any blocking required beneath the legs to render the legs suitable to lift and stabilize the vehicle.

According to another aspect, the sensor arrangement can comprise a pressure sensor at each leg.

According to another aspect, the computing facility can be adapted calculate, utilizing the level, the position of the legs relative to the dwelling and the position of the dwelling relative to the wheels, whether the legs would have sufficient lift to level and stabilize the dwelling assuming that the ground beneath the dwelling is a planar surface parallel to the floor and coincident with the design bottom of the wheels.

According to another aspect, the computing facility can be adapted to generate an indication as to any blocking required beneath the legs to render the legs suitable to lift and stabilize the vehicle.

According to another aspect of the invention, the shells can each have a nose wall extending from the floor to the ceiling and from which the ceiling extends rearwardly, the nose walls of the shells defining a smoothly contoured bifurcated surface when the shells are in the collapsed position.

According to another aspect of the invention, the body can have a nose wall that has an extended and a retracted position, the nose wall of the body defining, in combination with the nose walls of the shells, a smoothly contoured trifurcated surface when the shells are in the expanded position and the nose wall of the body is in the extended position, the nose wall of the body being disposed rearwardly of the bifurcated surface when the shells are in the collapsed position.

Forming another aspect of the invention is a dwelling for use with a chassis adapted for road transport, the apparatus comprising:
a body connected in use to the chassis, the body defining a floor and a ceiling disposed in stacked spaced relation to one another, the floor being disposed above the chassis and horizontal; and
a shell comprising:
   a floor and a ceiling disposed in stacked spaced relation to one another; and
   a wall from which the floor and ceiling protrude,
the shell being mounted for movement between:
   a collapsed position, wherein the wall is disposed in flanking relation to the body, the ceiling of the shell overlies the ceiling of the body and the floor of the shell overlies the floor of the body; and
   an expanded position, wherein the wall is relatively distal to the body, the ceiling of the shell defines an extension of the ceiling of the body and the floor of the shell defines an extension of the floor of the body and is coplanar therewith,
the floor of one or more of the shell and the body being shaped such that, in the expanded position of the shell, an aperture is defined, the aperture being spanned by a pair of coplanar panels, each hinged to the other panel and to a respective one of the floor of the shell and the floor of the body.

According to another aspect, in the collapsed position of the shell, the panels are folded against one another.

According to another aspect, in the collapsed position of the shell, the panels protrude downwardly from the floor.

According to another aspect of the invention, the shells can move rearwardly relative to the body during movement from the collapsed position to the expanded position.

According to another aspect of the invention, the shells each have a nose wall defining a front of the shell, the nose walls of the shells being contiguous when the shells are in the collapsed position.

According to another aspect of the invention, the body has a nose wall defining a front of the shell, the nose wall of the body defining being contiguous with the nose wall of each shell when the shells are in the expanded position.

Advantages, features and characteristics of the present invention will become evident upon a review of the following detailed description with reference to the appended drawings, the latter being briefly described hereinafter.

### BRIEF DESCRIPTION OF THE DRAWINGS

FIG. 1 is a top, side, front view of a mobile dwelling according to an embodiment of the invention and in a collapsed configuration;

FIG. 2 is an exploded view of the structure of FIG. 1;

FIG. 3 is a rear, top, side view of the structure of FIG. 1;

FIG. 4 is a rear view of the structure of FIG. 1;

FIG. 5 is a top view of the structure of FIG. 1;

FIG. 6 is a view similar to FIG. 1 showing the shells slightly separated;

FIG. 7 is a rear, top, side view of the structure of FIG. 6;

FIG. 8 is a rear view of the structure of FIG. 6;

FIG. 9 is a top view of the structure of FIG. 6;

FIG. 10 is a view similar to FIG. 6 showing the shells further separated;

FIG. 11 is a rear, top, side view of the structure of FIG. 10;

FIG. 12 is a rear view of the structure of FIG. 10;

FIG. 13 is a top view of the structure of FIG. 10;

FIG. 14 is a view similar to FIG. 10 showing the shells further separated;

FIG. 15 is a rear, top, side view of the structure of FIG. 14;

FIG. 16 is a rear view of the structure of FIG. 14;

FIG. 17 is a top view of the structure of FIG. 14;

FIG. 18 is a view similar to FIG. 1 showing the shells in the expanded configuration;

FIG. 19 is a rear, top, side view of the structure of FIG. 18;

FIG. 20 is a rear view of the structure of FIG. 18;

FIG. 21 is a top view of the structure of FIG. 18;

FIG. 22 is a schematic interior view along A-A of FIG. 5;

FIG. 23 is a schematic interior view along E-E of FIG. 21;

FIG. 24 is a schematic view at A-A of FIG. 5 showing a bearing in detail;

FIG. 25 is a schematic view at B-B of FIG. 9 showing a bearing in detail;

FIG. 26 is a schematic view at C-C of FIG. 14 showing a bearing in detail;

FIG. 27 is a schematic view at D-D of FIG. 17 showing a bearing in detail;

FIG. 28 is a schematic view at E-E of FIG. 21 showing a bearing in detail; and

FIG. 29 is a schematic plan view showing the bearing arrangement in plan when the shells are in the expanded configuration;

FIG. 30 is a top view of the dwelling part of the trailer of FIG. 1 in the expanded position;

FIG. 31 is a top, left, perspective view of the structure of FIG. 30;

FIG. 32 is a rear, partially cut-away view of the structure of FIG. 30;

FIG. 33 is a rear, right top, perspective partially cut-away view of the structure of FIG. 30;

FIG. 34 is a view along section 34-34 of FIG. 30, show the platform in the raised position;

FIG. 35 is a view similar to FIG. 34 showing the platform in the lowered position;

FIG. 36 is a view similar to FIG. 31 showing the platform in the lowered position;

FIG. 37 is a view similar to FIG. 35 showing the carriage in the lowered position;

FIG. 38 is a view similar to FIG. 36 showing the carriage in the lowered position;

FIG. 39 is a view similar to FIG. 37 showing the platform extended;

FIG. 40 is a view similar to FIG. 38 showing the platform extended;

FIG. 41 is a view similar to FIG. 39 showing the platform fully lowered;

FIG. 42 is a view similar to FIG. 40 showing the platform fully lowered;

FIG. 43 is a view similar to FIG. 39;

FIG. 44 is a view similar to FIG. 40;

FIG. 45 is a view similar to FIG. 43 showing the carriage in the raised position;

FIG. 46 is a view similar to FIG. 44 showing the carriage in the raised position;

FIG. 47 is a right side view of a trailer according to an example embodiment of the invention;

FIG. 48 is a left side view of the structure of FIG. 47;

FIG. 49 is a front view of the structure of FIG. 47;

FIG. 50 is a rear view of the structure of FIG. 47;

FIG. 51 is a top view of the structure of FIG. 47, with portions shown in phantom for clarity;

FIG. 52 is a top view of the structure of FIG. 47 coupled to a tow vehicle on an uneven surface;

FIG. 53 is a right side view of the structure of FIG. 52, with the ground surface at 53-53 of FIG. 52 and the left trailer wheel shown in phantom;

FIG. 54 is a left side view of the structure of FIG. 52, with the ground surface at 54-54 of FIG. 52 and the right trailer wheel shown in phantom;

FIG. 55 is a front view of the trailer of FIG. 53, with the ground surface at 55-55 of FIG. 52;

FIG. 56 is a rear view of the trailer of FIG. 53, with the ground surface at 56-56 of FIG. 52;

FIG. 57 is a view similar to FIG. 52, but including a phantom image of the trailer level;

FIG. 58 is a view similar to FIG. 53 of the structure of FIG. 57, showing the rotation by which the trailer pivots to level;

FIG. 59 is a view similar to FIG. 54 of the structure of FIG. 57, showing the rotation by which the trailer pivots to level;

FIG. 60 is a view similar to FIG. 55 of the structure of FIG. 57, showing the rotation by which the trailer pivots to level;

FIG. 61 is a view similar to FIG. 56 of the structure of FIG. 57, showing the rotation by which the trailer pivots to level;

FIG. 62 is a view similar to FIG. 52, with the legs all extended to ground;

FIG. 63 is a view similar to FIG. 53, with the legs all extended to ground;

FIG. 64 is a view similar to FIG. 54, with the legs all extended to ground;

FIG. 65 is a view similar to FIG. 55, with the legs all extended to ground;

FIG. 66 is a view similar to FIG. 56, with the legs all extended to ground;

FIG. 67 is a view similar to FIG. 52, with the tongue leg fully extended, the other legs all retracted and the tow vehicle removed;

FIG. 68 is a right side view of the structure of FIG. 67;

FIG. 69 is a left side view of the structure of FIG. 67;

FIG. 70 is a front view of the structure of FIG. 67;

FIG. 71 is a rear view of the structure of FIG. 67;

FIG. 72 is a view similar to 52, with the trailer level;

FIG. 73 is a right side view of the structure of FIG. 72;

FIG. 74 is a left side view of the structure of FIG. 72;

FIG. 75 is a front view of the structure of FIG. 72;

FIG. 76 is a rear view of the structure of FIG. 72;

FIG. 77 is a perspective view of the trailer with the shells in the expanded configuration and the nose wall of the body in a retracted position;

FIG. 78 is a top view of FIG. 77;

FIG. 79 is a front view of the structure of FIG. 77;

FIG. 80 is a view along section 80-80 of FIG. 78;

FIG. 81 is a view along section 81-81 of FIG. 79;

FIG. 82 is a view of the structure of FIG. 77 with the nose wall of the body in an extended position;

FIG. 83 is a top view of FIG. 82;

FIG. 84 is a front view of the structure of FIG. 82;

FIG. 85 is a view along section 85-85 of FIG. 83;

FIG. 86 is a view along section 86-86 of FIG. 84;

FIG. 87 is a view along 87-87 of FIG. 5;

FIG. 88 is a view of the structure of FIG. 87, with the shells in the collapsed position;

FIG. 89 is a plan view of the structure of FIG. 87;

FIG. 90 is a plan view of the structure of FIG. 88;

FIG. 91 is a front perspective view of a trailer according to another embodiment of the invention, with the shells in the collapsed position;

FIG. 92 is a view similar to FIG. 91, with the shells slightly separated relative to FIG. 91;

FIG. 93 is a view similar to FIG. 92, with the shells further separated from one another;

FIG. 94 is a view similar to FIG. 93, with in the expanded position;

FIG. 95 is a rear view of the trailer of FIG. 91;

FIG. 96 is a rear view of the trailer of FIG. 92;

FIG. 97 is a rear view of the trailer of FIG. 93; and

FIG. 98 is a rear view of the trailer of FIG. 94.

### DETAILED DESCRIPTION

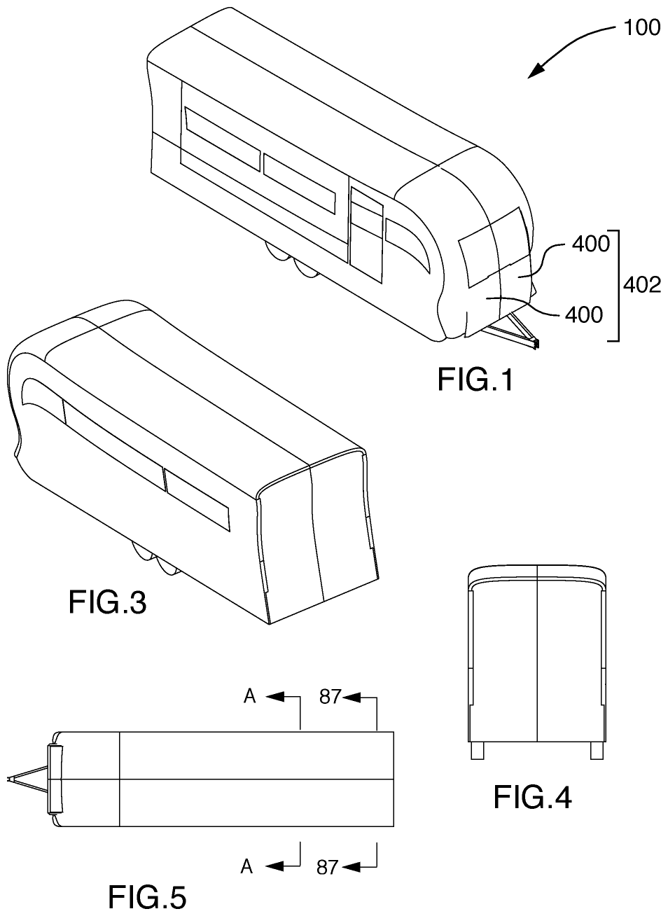

A mobile dwelling 100 is shown in FIG. 1 that is illustrative of the invention.

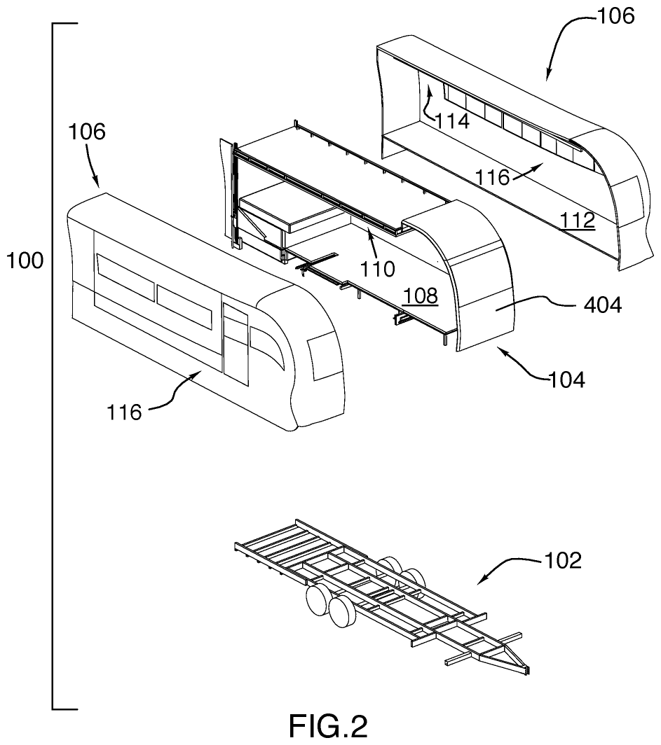

With reference to FIG. 2, wherein the dwelling 100 is shown in exploded view, the dwelling will be understood to comprise a wheeled chassis 102, a body 104, and a pair of shells 106.

The chassis is a tandem trailer chassis.

The body is mounted to the chassis and defines a horizontal floor 108 and a horizontal ceiling 110 disposed in stacked spaced relation to one another, the floor being disposed above the chassis. Body further comprises a roof that is substantially horizontal when the body is level and a nose wall that is substantially perpendicular to the roof and extends from the floor to the roof.

Each shell of the pair comprises: a floor 112 and a ceiling 114 disposed in stacked spaced relation to one another; and a wall 116 from which the floor and ceiling protrude, that wall of the shell being perpendicular to the wall of the body.

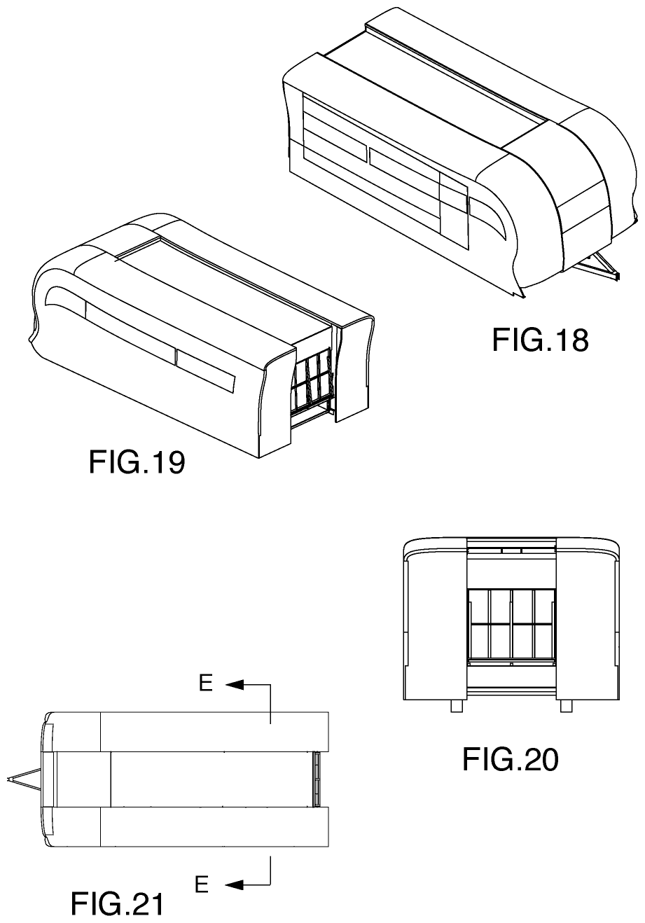

In the dwelling, the shells are mounted for movement relative to the body and chassis between a collapsed position shown in FIG. 1 and an expanded position shown in FIG. 18.

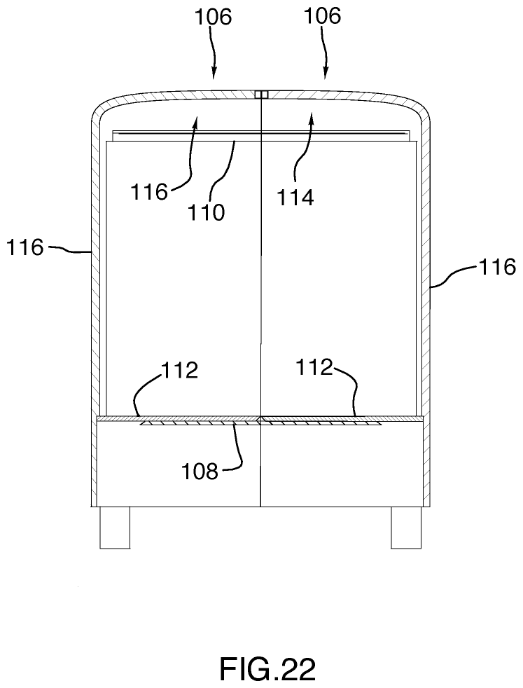

In the collapsed position, as best seen in FIG. 22:
the shells are relatively proximal to one another;
the walls are vertical and disposed in flanking relation to the body;
the ceilings of the shells overly the ceiling of the body and abut one another; and
the floors of the shells are horizontal, overly the floor of the body and abut one another.

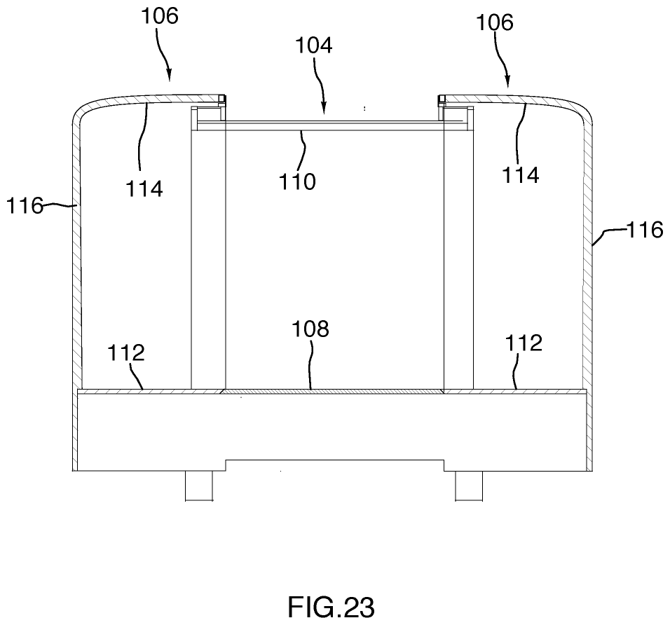

In the expanded position, as best seen in FIG. 23:
the shells are relatively distal to one another;
the ceilings of the shells define extensions of the ceiling of the body;
the floors of the shells define extensions of the floor of the body, are horizontal and are coplanar with the floor of the body; and
the walls are vertical.

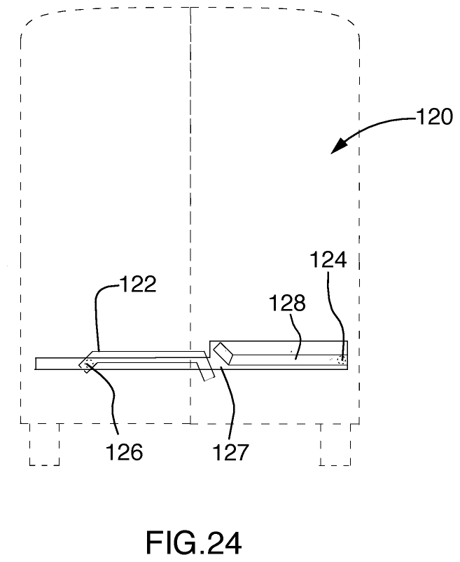

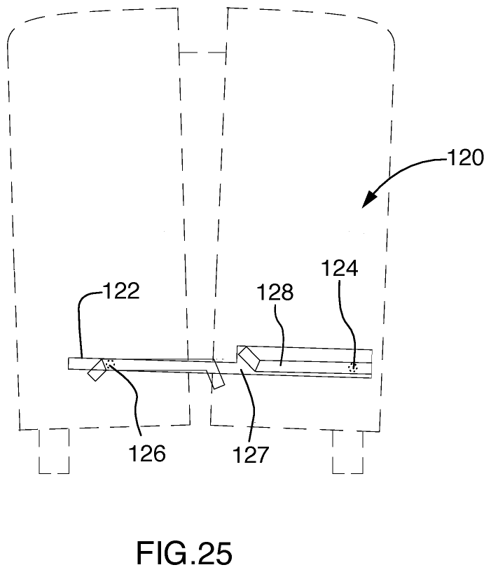

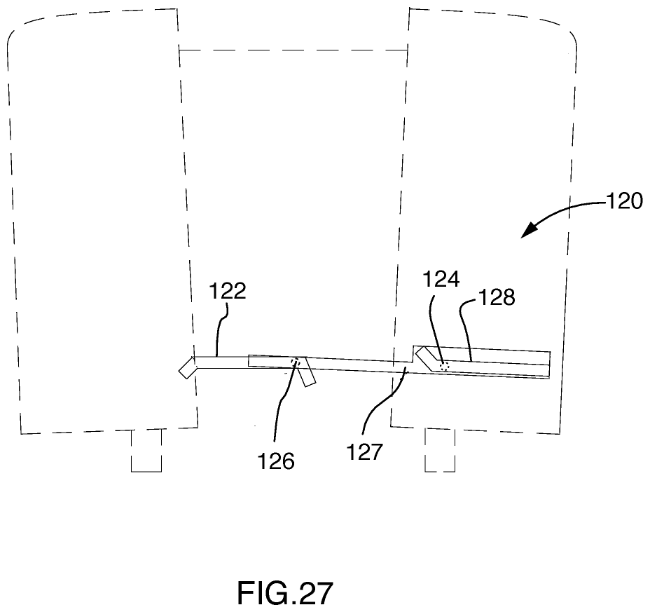

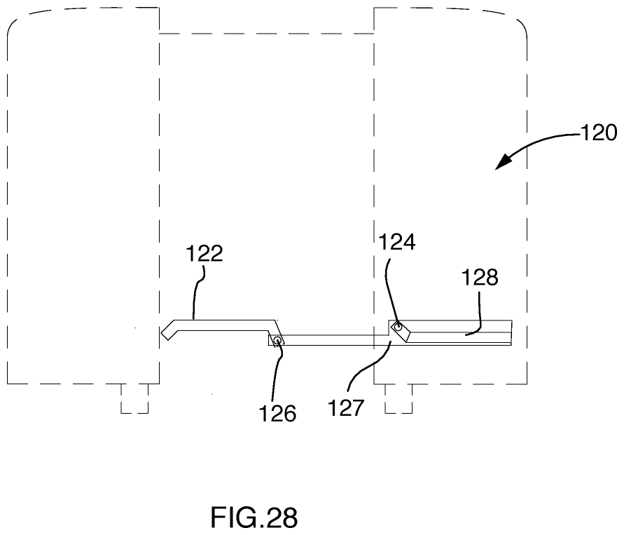

A bearing 118 arrangement is shown in FIGS. 24-29 which provides for the mobility indicated above and will be understood to comprise a pair of bearings 120 for each shell, each bearing comprising:
a track 122 fixedly mounted to the chassis;
a roller 124 rotatably mounted to the chassis;
a roller 126 disposed in the track of the chassis to be guided thereby for movement and rotatably mounted to the shell by means of a lever arm 127; and
a track 128 fixedly mounted to the shell and in receipt of the roller of the chassis for guided movement thereof.

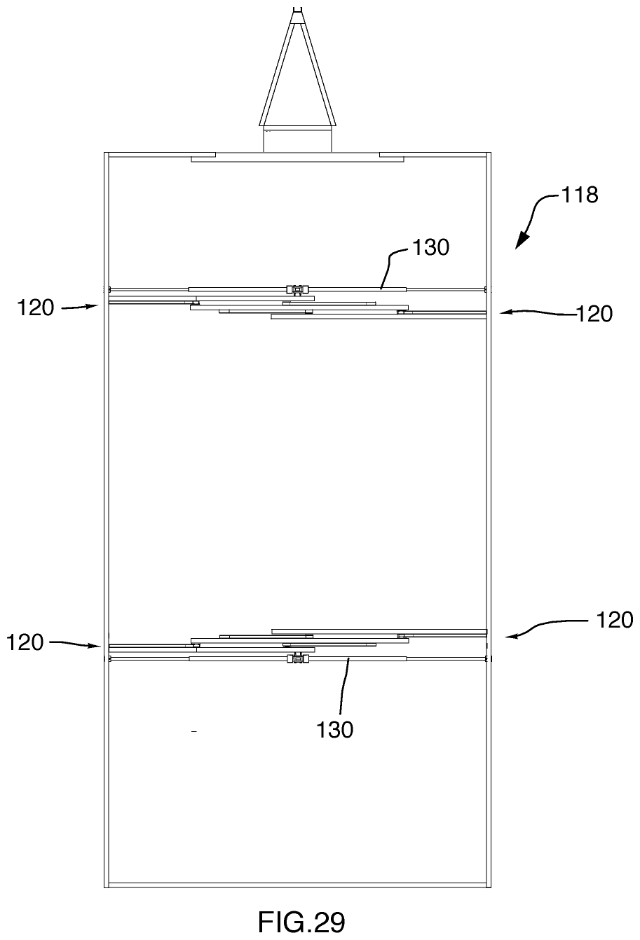

All of the bearings are shown in FIG. 29; for simplicity, only a single bearing is shown in FIGS. 24-28.

The manner in which the rollers and tracks allow the guided movement of the shells is evident from the illustrations such that further explanation of the specific movements of the rollers in the tracks is neither required nor provided but it will be noted for posterity that the tracks and rollers shown provide for the following motions of the shells:
as the shells initially separate from the collapsed position, their inner edges lift and outer edges drop;
as the shells reach the expanded configuration, their inner edges drop and outer edges lift;
as the shells initially move from the expanded configuration towards the collapsed configuration, their inner edges lift and outer edges drop; and
as the shells reach the collapsed configuration, their inner edges drop and outer edges lift.

It will of course be apparent to persons of ordinary skill that forces will need to be applied, for example, by electric actuators or the like, between the body/chassis and shells to arrange for the aforesaid movement. A pair of actuators 130 are shown in FIG. 29. However, the application is a matter of routine to persons of ordinary skill in the art and will vary widely based upon, inter alia, the construction of the chassis and shell. As such, further detail is not provided and is not required. Persons of ordinary skill will similarly appreciate the need to selectively lock the shells, for example, with solenoid pins, against movement at the collapsed and expanded configurations: this again is a matter of routine to persons of ordinary skill in the art such that further detail is not provided and is not required.

### Lift Apparatus

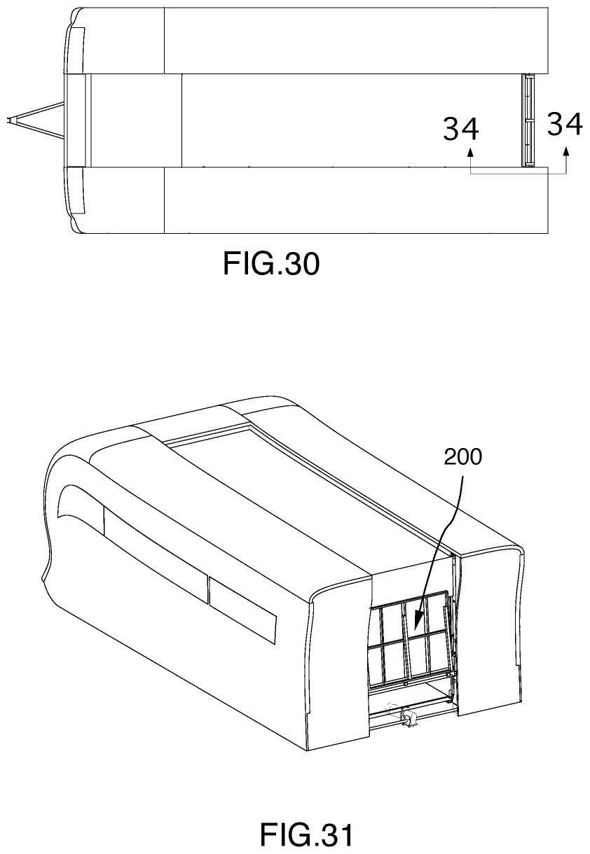

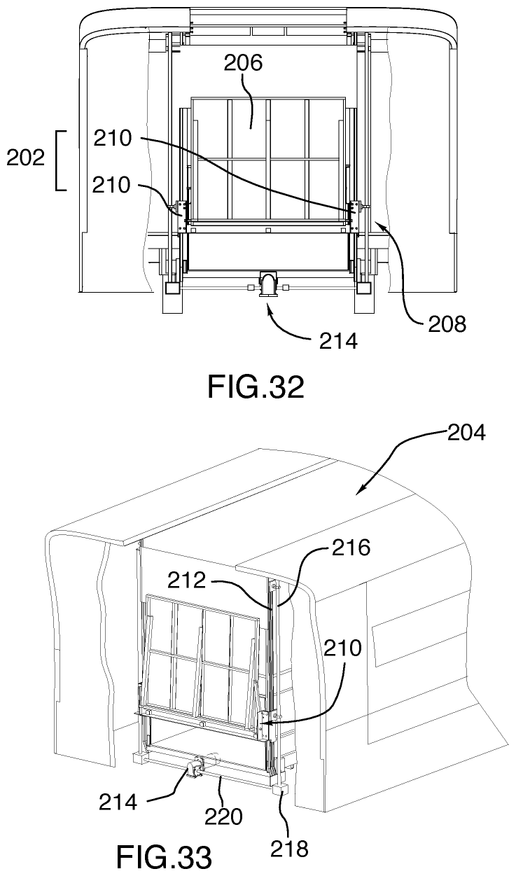

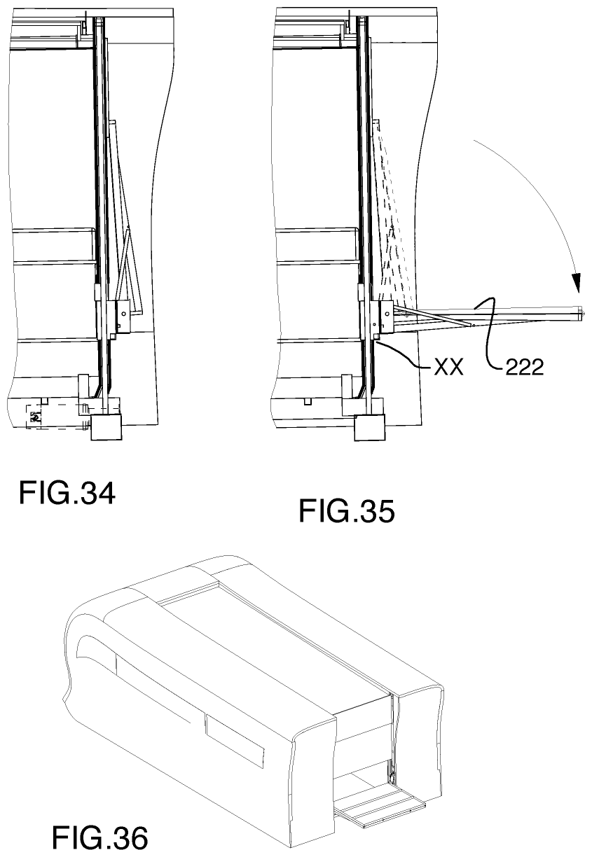

FIGS. 30-34 show an embodiment of a lift apparatus 200 that forms another aspect of the invention. It is noted that, in FIGS. 30-34, the shells are in the extended configuration: in the collapsed position of the shells, the lift apparatus is disposed between the walls and shells and not visible.

The lift shown will be understood to include a carriage 202, a drive mechanism 204, a platform 206 and an inclinator 208. The carriage comprises a pair of bearings 210. Each bearing is mounted for sliding movement to a rail 212 that is in turn mounted to the wall. The carriage will be understood to be at a lowered position in FIGS. 30-34.

The drive mechanism comprises a motor 214, a threaded shaft 216 for each bearing, a gearbox 218 for each threaded shaft and a shaft 220 for each gearbox. The motor drives the shafts. Each shaft is operatively connected to the gearbox provided therefor such that operation of the motor turns the threaded shaft provided for said gearbox, thereby driving the bearing provided for said threaded shaft along the rail to which the bearing is mounted.

The platform is a bi-fold ramp. The platform will be understood to be folded upon itself in FIGS. 30-34 and in a raised position, substantially parallel to the wall.

The inclinator is mounted to the bearings for movement therewith and provides for movement of the bifold ramp about an axis XX that is parallel to the wall and horizontal when the dwelling is level. The inclinator will be understood to be defined by a pair of rotary actuators, not visible.

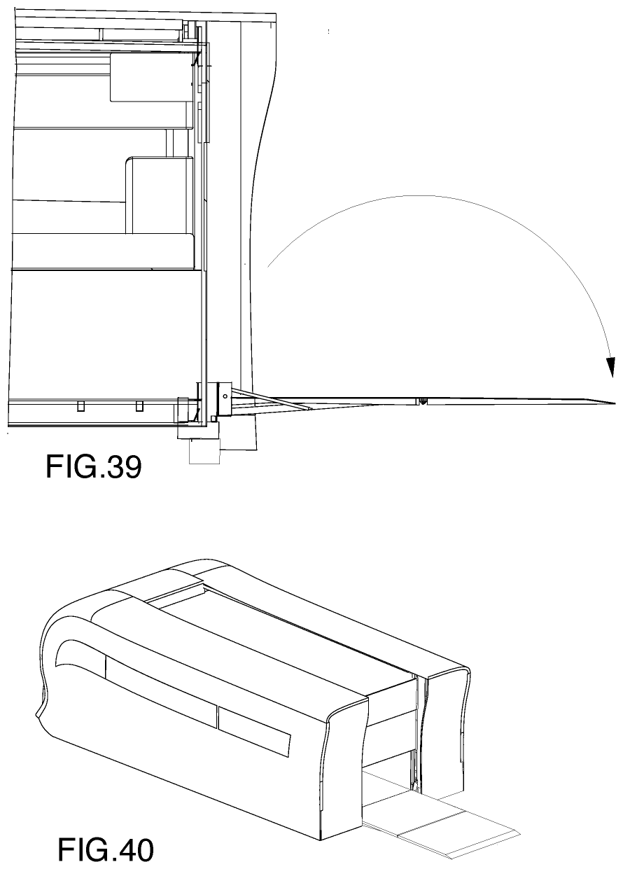

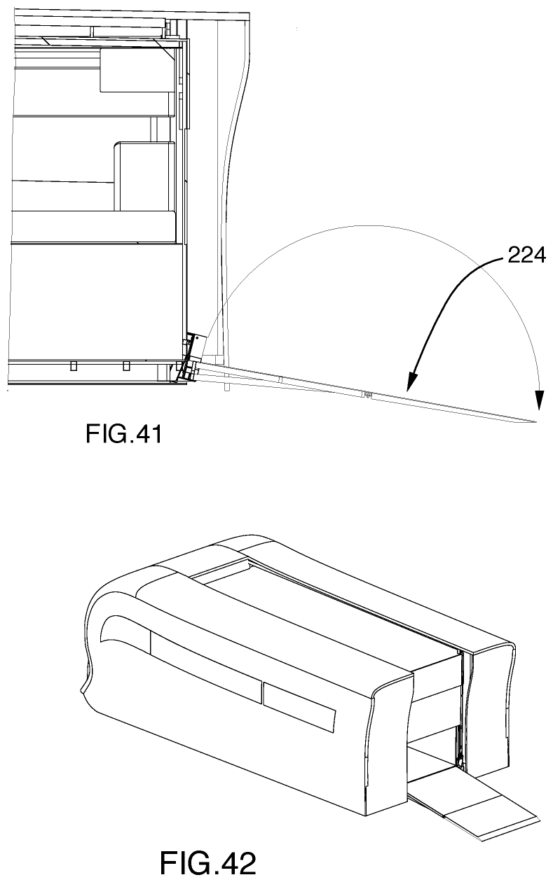

The operation of the example lift apparatus will become evident upon review of FIGS. 35 to 45.

With initial reference to FIG. 35, the platform will be seen to be movable from the raised position to a lowered position by the inclinator when the shells are extended. In the lowered position the platform defines an upper surface 222 that is horizontal when the dwelling is level and projects substantially perpendicularly from the wall.

The carriage will be seen in FIG. 37 to be moveable to a lowered position, distal to the roof.

FIG. 39 shows the bi-fold ramp unfolded.

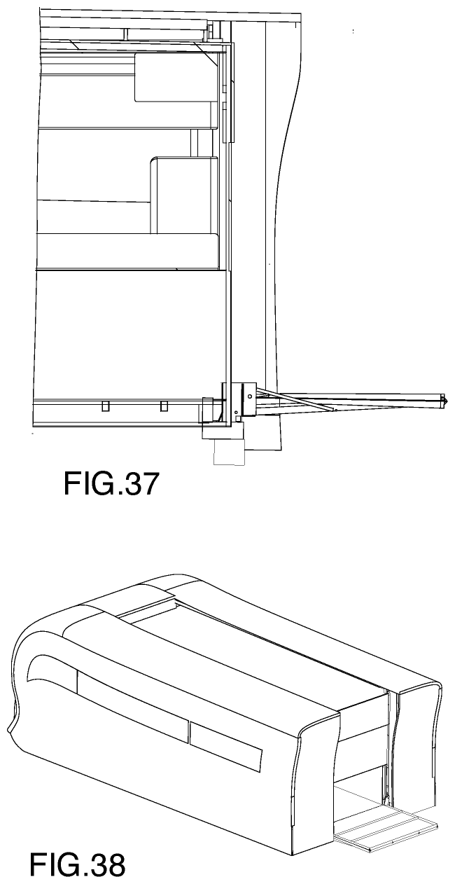

FIG. 41 shows that that, when the bi-fold ramp is unfolded and at a loading position, projecting downward, and the carriage is at the lowered position, the platform extends to the ground to define a ramp 224.

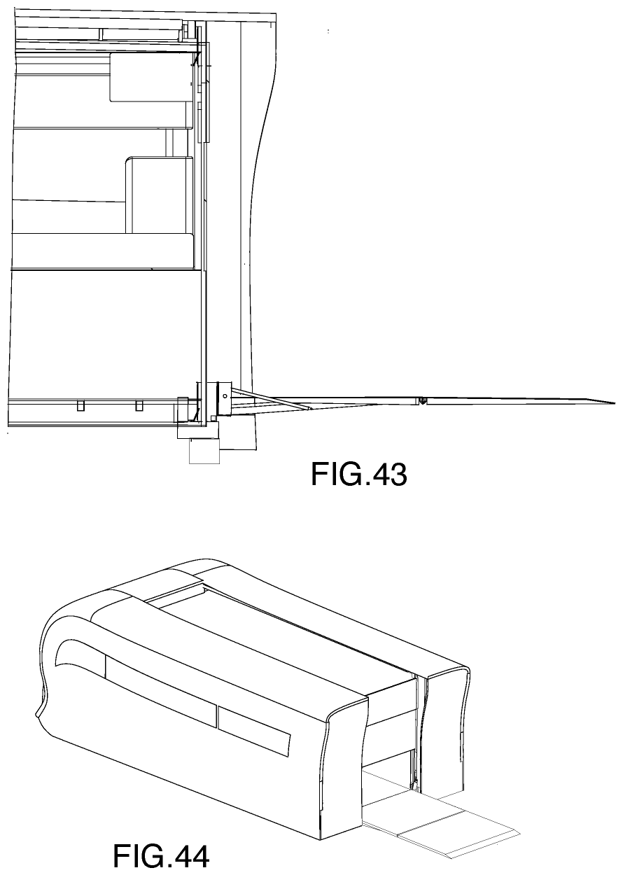

FIG. 43 shows that the extended bi-fold ramp can be moved to the lowered position from the loading position.

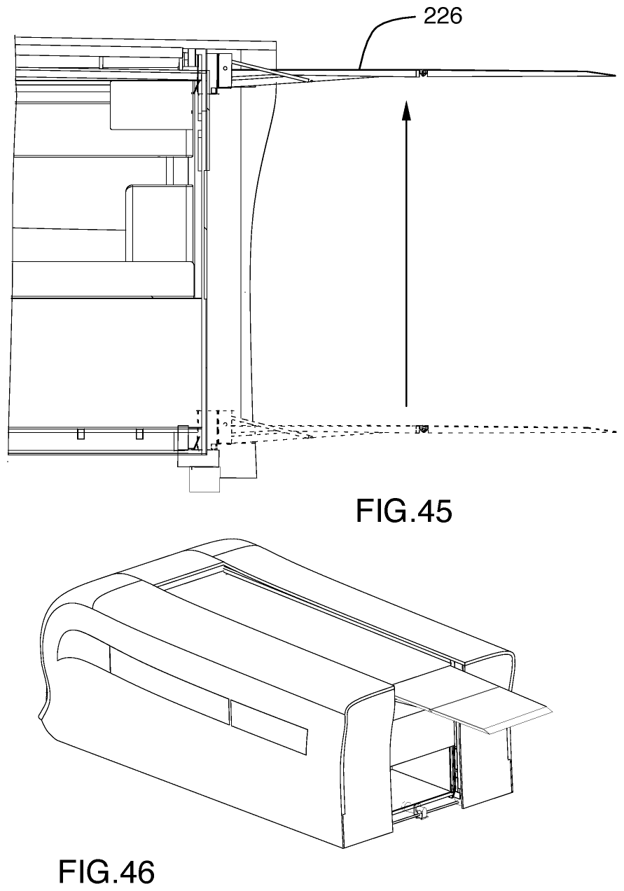

FIG. 45 shows that the carriage can move to a raised position, with the extended bi-fold ramp, whereat the platform has a surface 226 which is substantially coplanar and contiguous with the roof. Persons of ordinary skill will readily appreciate that the foregoing allows, inter alia, wheelchairs and other loads to be relatively easily transported to the roof, to take advantage of the roof deck.

### Levelling

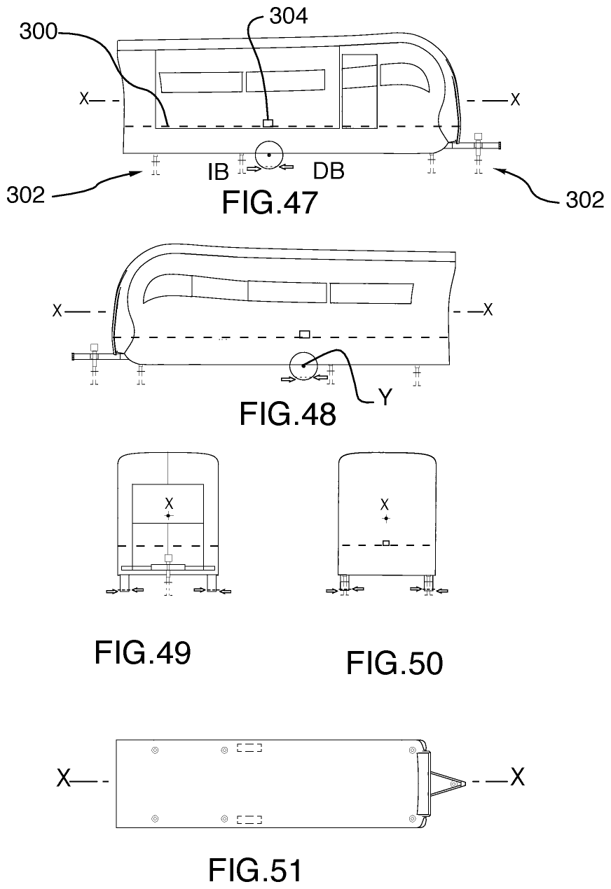

Reference is now made to FIGS. 47-51 which show details of an example levelling apparatus mounted for use to a dwelling operatively mounted to wheels for road transport in the manner of a trailer. The trailer will be understood to have a flat floor 300, a longitudinal axis X, a rotation axis Y, a design bottom DB and an ideal bottom IB. The design bottom is the flattened surface of the wheels when the trailer is on a horizontal surface. The ideal bottom is defined by that part of the wheels furthest from the floor when the trailer has been lifted off its wheels.

The apparatus will be understood to comprise: a level, a plurality of extendable legs 302, a sensor arrangement, a computing facility and an actuator, all generally indicated with 304.

The level is an accelerometer operatively coupled to the dwelling for movement therewith.

The legs are connected to the dwelling in supporting relation and at known positions relative thereto.

Each leg has a known stroke and further has an encoder which sends a signal representative of the amount by which the leg has been extended.

The sensor arrangement is for determining the lift available at each leg [the extent by which the fully extended leg would extend beneath the ground surface] and comprises a pressure sensor at each leg, more particularly, a power sensor.

The computing facility is adapted to calculate: (i) utilizing the sensor arrangement, the level, the known positions of the legs and the position of the dwelling relative to the wheels, whether the legs have sufficient lift to level and stabilize the dwelling; and (ii) utilizing the level, the known positions of the legs relative and the position of the dwelling relative to the wheels, whether the legs would have sufficient lift to level and stabilize the dwelling assuming that the ground beneath the dwelling is a planar surface parallel to the floor and coincident with the design base of the wheels.

The computing facility is further adapted to generate, on the basis of the calculations: (i) an indication that the legs have sufficient lift to level and stabilize the dwelling; (ii) an indication that the legs do not have sufficient lift to level and stabilize the dwelling; and (iii) an indication as to any blocking required beneath the legs to render the legs suitable to lift and stabilize the dwelling.

The actuator is an arrangement of motors adapted to extend the legs to level and stabilize the dwelling when the legs have sufficient lift available, each motor being associated with one of the power sensors.

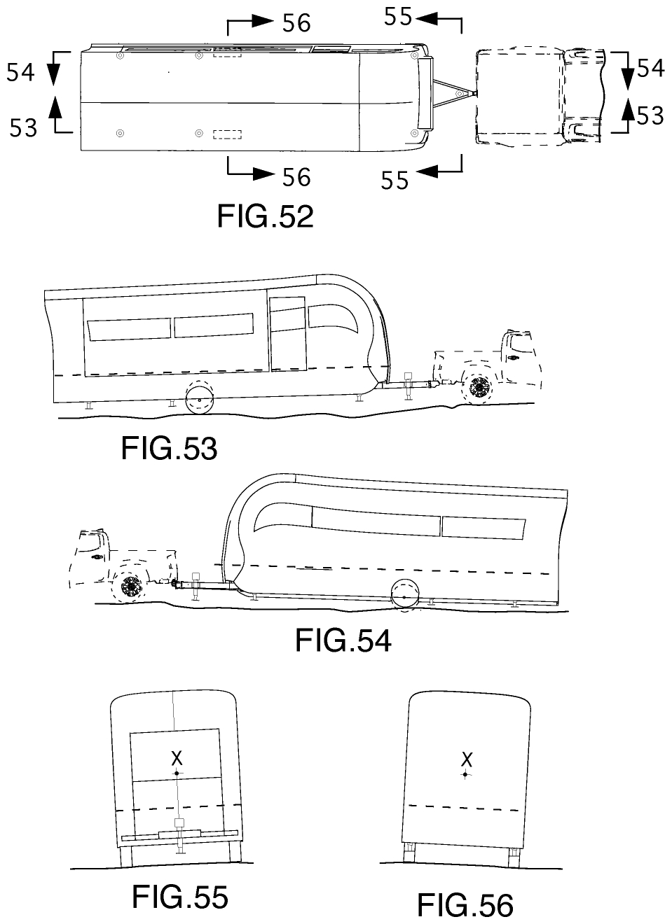

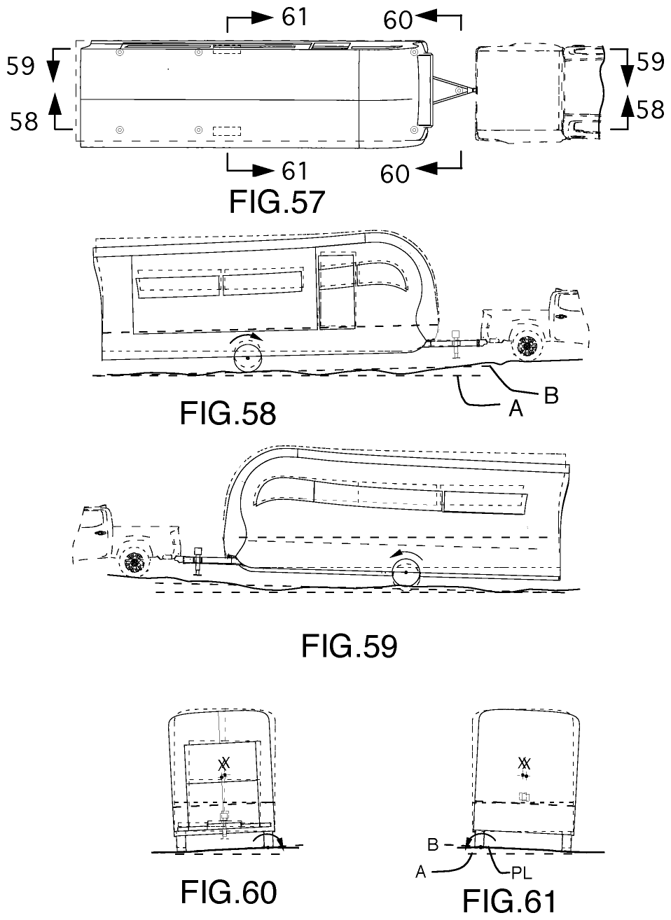

FIGS. 52-76 show the apparatus in use.

Reference is initially made to FIG. 52-56 wherein the trailer is coupled to a tow vehicle.

### Site Finding

When it is desired to park the trailer, the operator of the tow vehicle activates the levelling system and the system indicates to the operator whether the location of the trailer appears sufficiently flat for parking. This is done by calculating, utilizing the level, the known positions of the legs and the position of the dwelling relative to the wheels, whether the legs would have sufficient lift to level and stabilize the dwelling assuming that the ground beneath the dwelling is a planar surface parallel to the dwelling and coincident with the design bottom of the wheels.

As the locations and maximum stroke of the legs are known, a notional plane A can be drawn showing the maximum reach of the legs, assuming the trailer is rotated level front to back about the rotation axis Y and then rotated to level about a pivot line PL that is parallel to the longitudinal axis of the trailer and coincident with the midpoint of the design bottom of the highermost of the wheels [as determined by the level]

Similarly, as the locations of the trailer wheels are known, and the orientation of the trailer is known, a plane B can be drawn showing a notional ground surface at the design bottom of the wheels and parallel to the floor.

If no part of plane B is more than a predetermined amount [the thickness of blocking carried by the trailer, if any, less the distance between the design bottom and the ideal bottom] above plane A within the footprint of the trailer, the legs will be assumed to have sufficient lift to level and stabilize the trailer and the system will indicate as much to the operator.

To the extent that the calculation suggests that blocking is required, the system will indicate to the operator which legs(s) require(s) blocking.

If any part of plane B is more than the predetermined amount above such elevations, the system will indicate to the operator that a new site should be selected.

Persons of ordinary skill will readily appreciate that the aforementioned indications can be provided in any number of methods, including but not limited to a phone app coupled to the system, for example, by Bluetooth.

The foregoing is illustrated in FIGS. 57-61: in these figures, the trailer is shown in solid line in its actual position and in phantom line in the position it would be if levelled by rotating the trailer about the pivot axis and the pivot line. It will be seen in these drawings, notional plane A is (within the footprint of the trailer) fully below notional plane B in all views, that is, the trailer is on a site that is suitable for parking.

### Elevation Finding

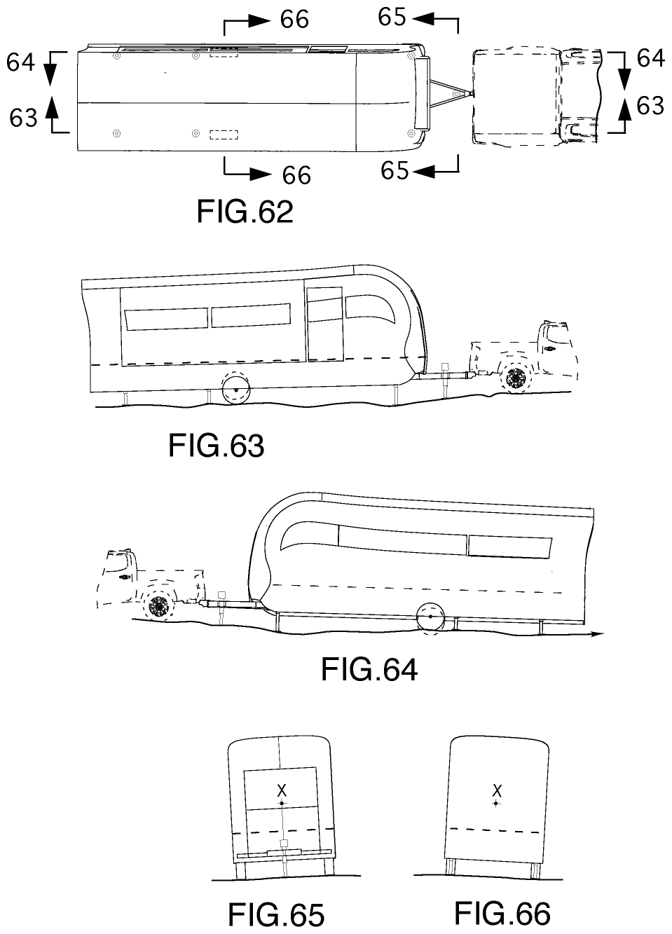

When the trailer has been positioned upon a suitable site and blocking has been placed as prompted, the operator triggers the computing functionality to extend all of the legs to ground/blocking. More specifically, each leg extends until the pressure sensor associated therewith is triggered, as shown in FIGS. 62-66.

### Calculating

With the legs all extended, since the locations of the legs are known, the orientation of the trailer is known, the existence of blocking beneath the legs is presumed, and the amount to which each leg is extended is known, the actual elevations of the ground/blocking beneath the trailer can be approximated as can the extent to which each leg must be extended to level and stabilize the trailer and the amount of blocking, if any, which must be placed beneath each leg, the latter information being relayed to the operator in the form of a prompt.

In situations where, for example, a leg is determined to be in a hollow such that available lift is not sufficient given the blocking available, the system will retract all of the legs and prompt the operator to find a new location.

### Site Preparation

In situations where the approximation calculation suggests that level can be attained if additional blocking is placed, the system will retract those legs, prompt the operator with blocking information and await confirmation from the operator that the required blocking, if any has been placed.

### Hitch Removal

In situations where the approximation calculation suggests that level can be attained [either pre- or post the above blocking step] the system will
prompt the operator to unlock the hitch and provide confirmation; and
upon confirmation that the hitch has been unlocked, retract the legs as necessary, raise the tongue off the ball, prompt the operator to move the tow vehicle and provide confirmation.

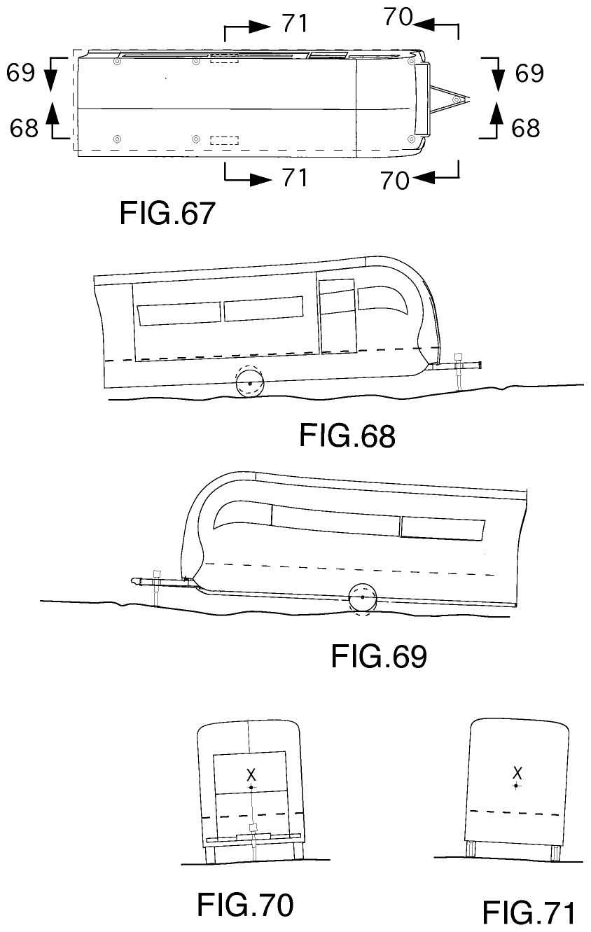

FIGS. 67-71 show the trailer supported on the tongue jack and the tow vehicle removed.

Upon receipt of confirmation, the levelling step is conducted.

### Levelling

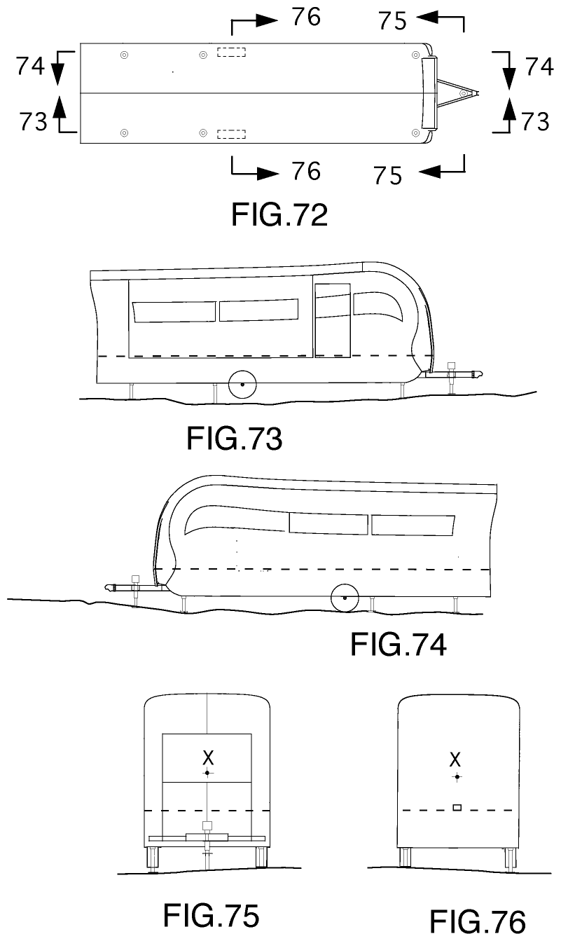

In the levelling operation, the system triggers all of the legs to retract/extend as per the calculation, thereby levelling the trailer as shown in FIGS. 72-76.

### Secondary Levelling

If the result of the above results in a levelling of the trailer within a predetermined tolerance, the levelling effort is concluded. Alternatively, the Calculation, Site Preparation and Levelling steps are repeated until the predetermined tolerance is achieved or the system prompts the operator to find a new site. It will be appreciated that this might result, for example, in swamp conditions.

### Reciprocating Nosepiece.

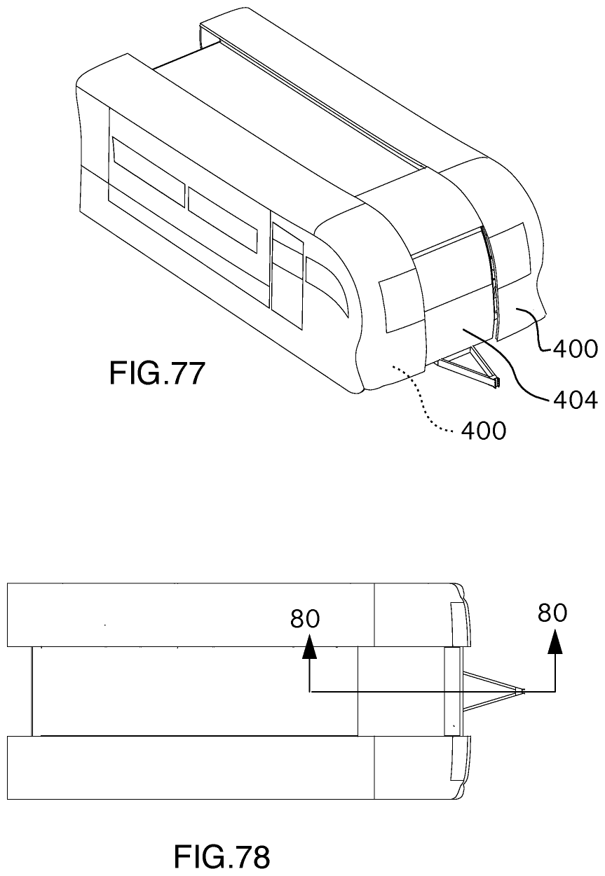

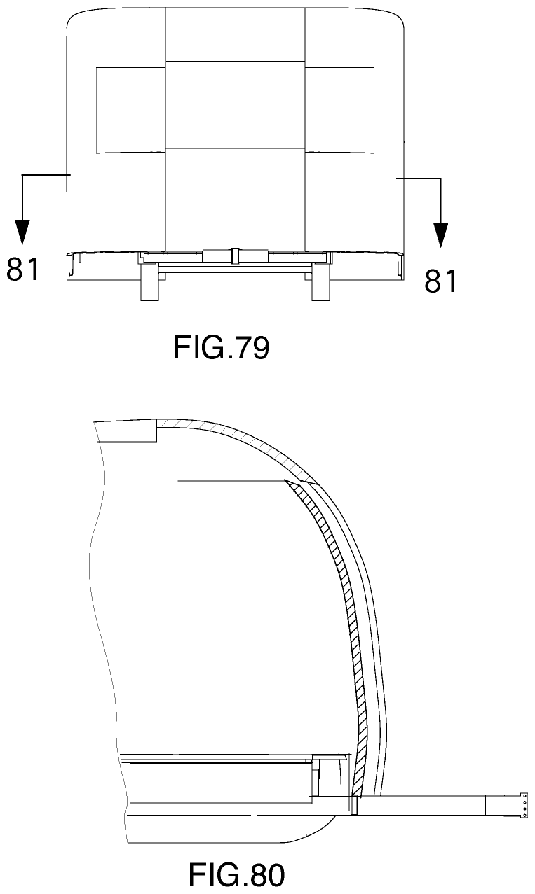

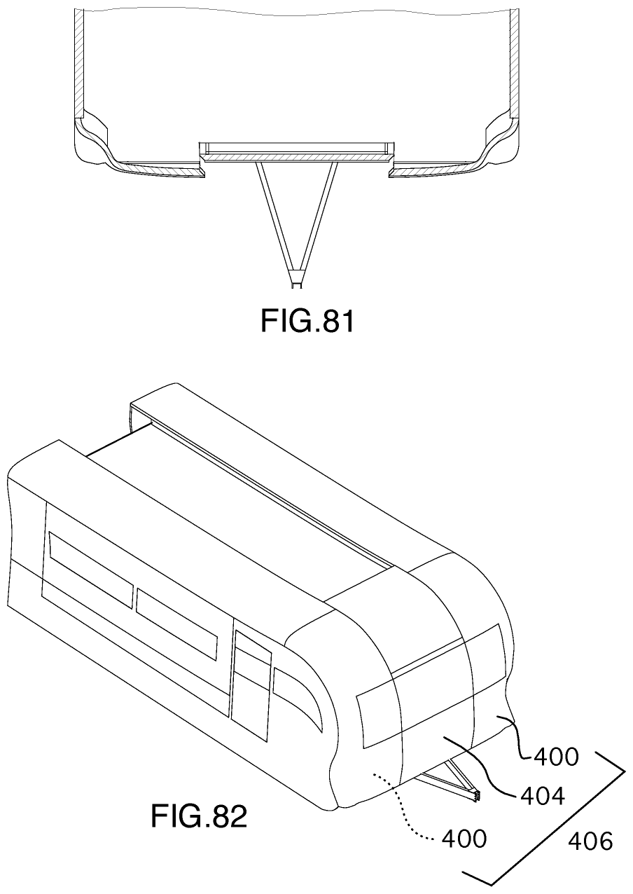

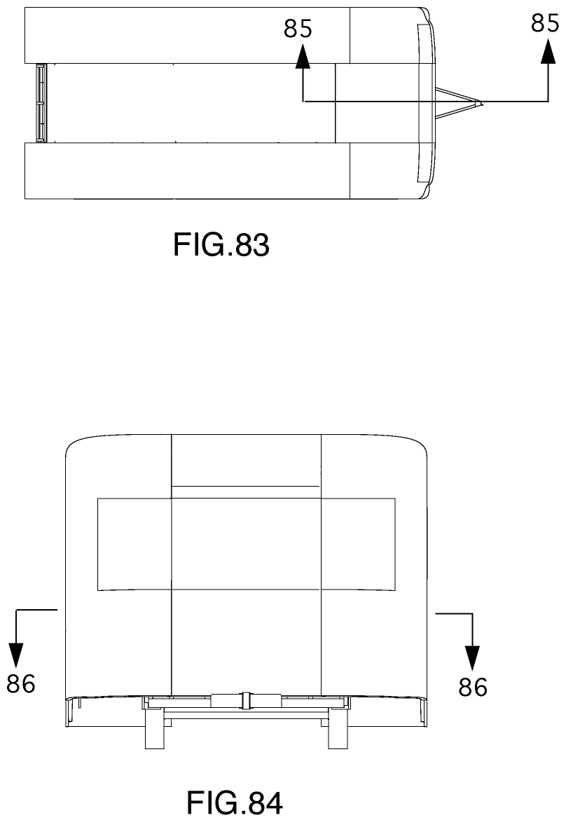

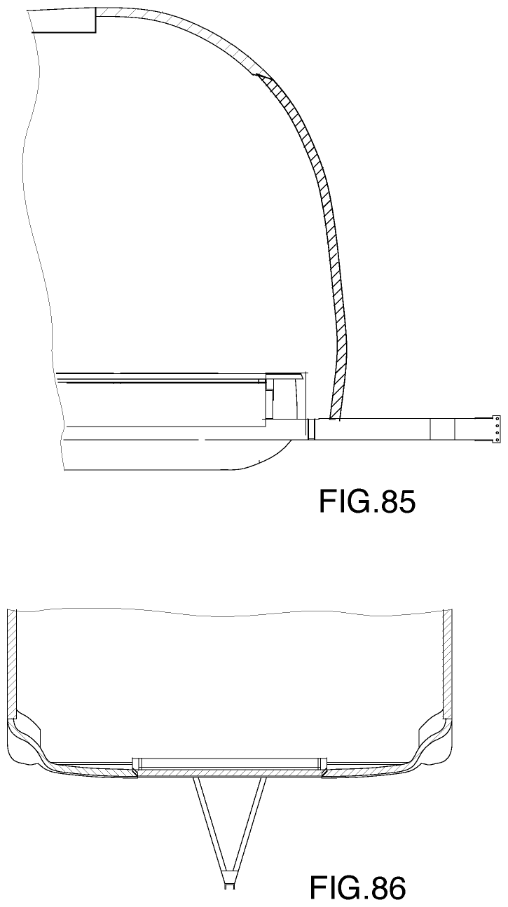

FIGS. 77 to 86 illustrate a design feature of the example trailer which forms another aspect of the invention.

By way of background, reference is initially made to FIG. 1, which shows the trailer in the collapsed position. Herein, it will be appreciated that each shell has a nose wall 400 extending from the floor to the ceiling and from which the ceiling extends rearwardly, the nose walls of the shells defining a smoothly contoured bifurcated surface 402 when the shells are in the collapsed position.

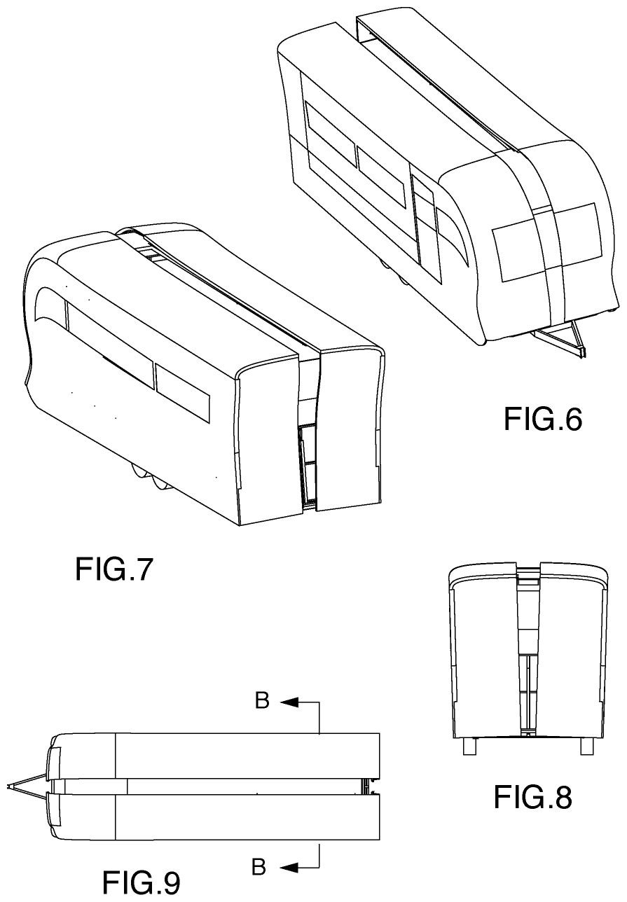

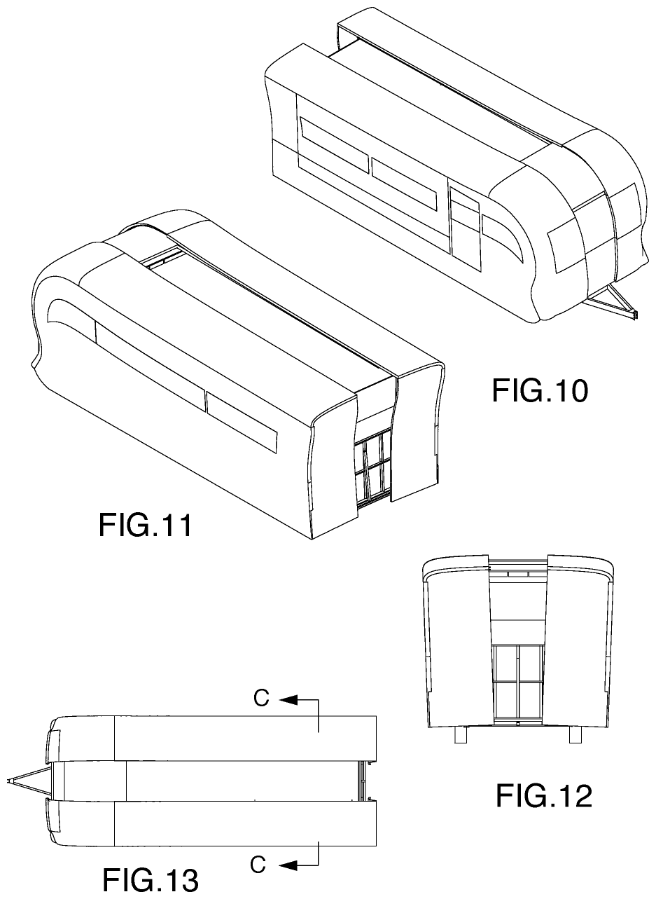

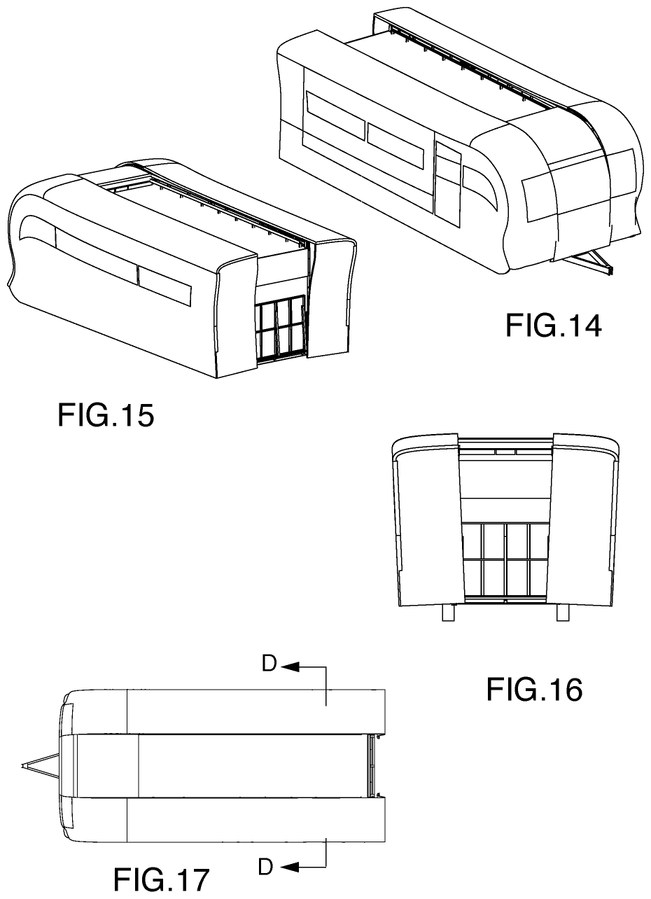

Reference is also made to FIG. 2, and FIG. 6, which illustrate that the body has a nose wall 404 which is concealed by the shells during motion of the shells towards the collapsed position such that the nose wall of the body is disposed rearwardly of the bifurcated surface when the shells are in the collapsed position.

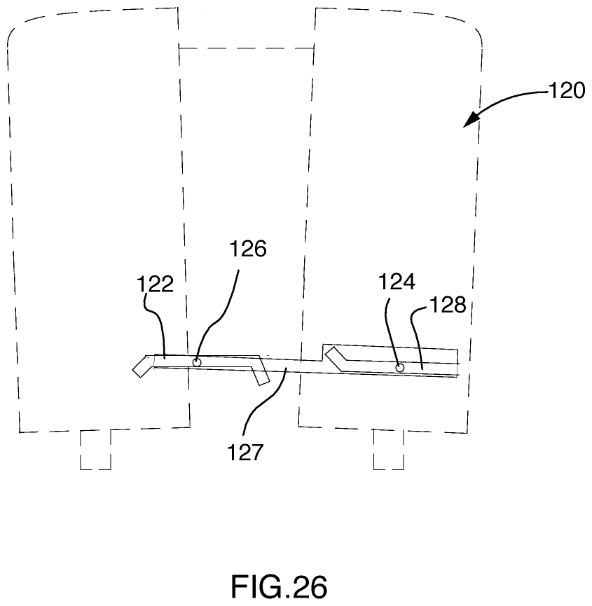

Turning now to FIGS. 77-86, it will be appreciated that the nose wall of the body that is movable on a track and by an actuator, neither shown, between an extended position shown in FIGS. 82-26 and a retracted position shown in FIGS. 77-85, the nose wall of the body defining, in combination with the nose walls of the shells, a smoothly contoured trifurcated surface 406 when the shells are in the expanded position and the nose wall of the body is in the extended position.

### Hinged Planar Surfaces

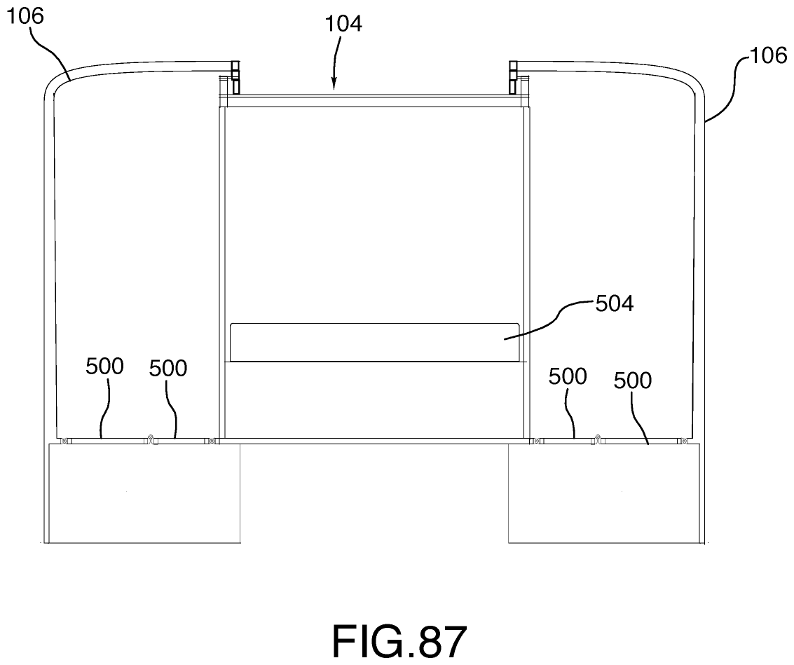

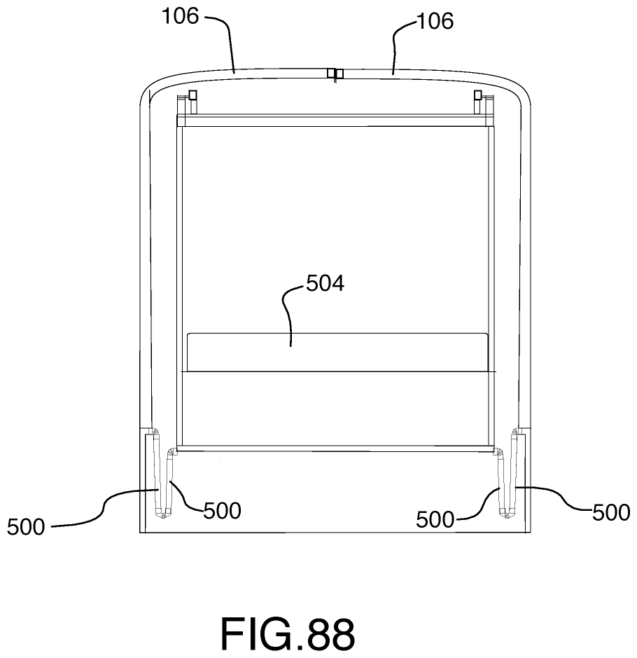

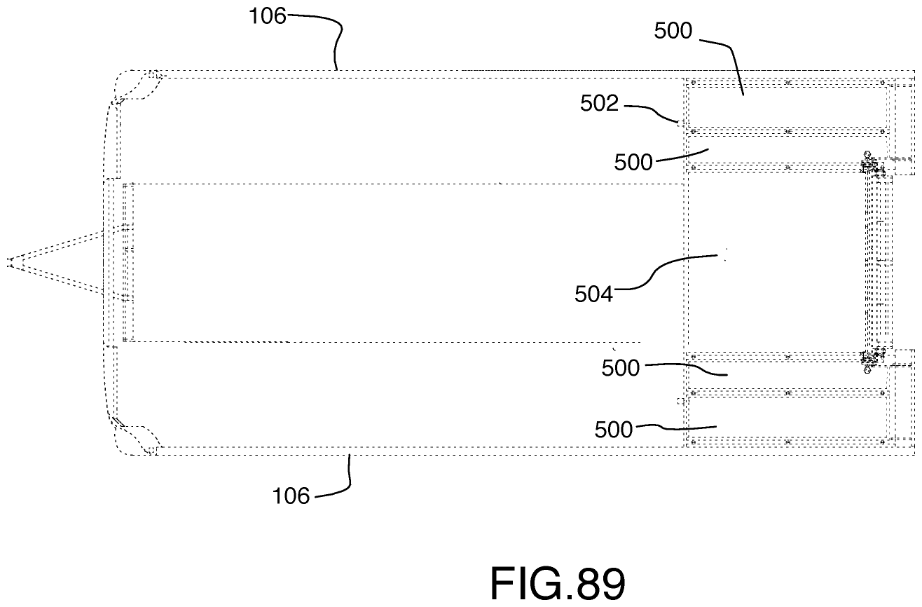

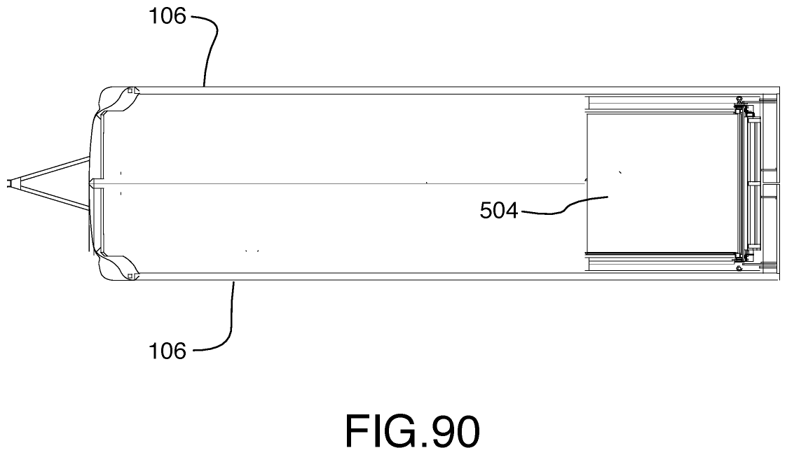

FIGS. 87-90 show a feature of the trailer of FIG. 5 that forms another aspect of the invention, more specifically, a pair of hinged panels 500 that:
in the expanded position of the trailer, span apertures defined in the floor formed by the shells and body and are locked to the floor of the shell by a solenoid driven plunger 502; and
in the collapsed position of the trailer, are folded against one another and protrude downwardly.

This structure is advantageous in situations wherein it is important that the floor of the shell not protrude over the floor of the body or, more generally, protrude into the volume of the body. In the embodiment illustrated, this hinged floor arrangement allows for a garage area to be defined in the body, to receive a small car or the like (not shown) by raising a bed 504 to the ceiling of the body (not shown).

### Sliding Sides

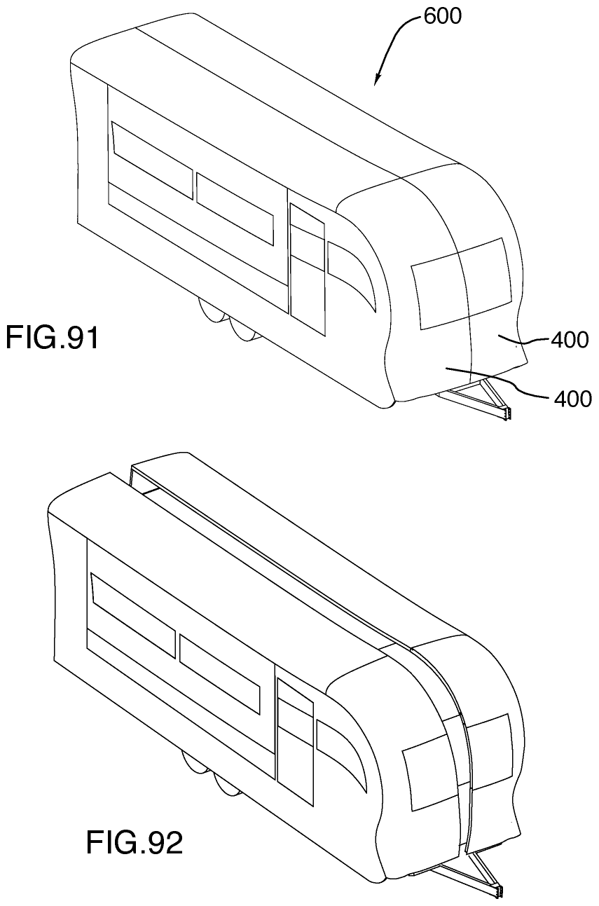

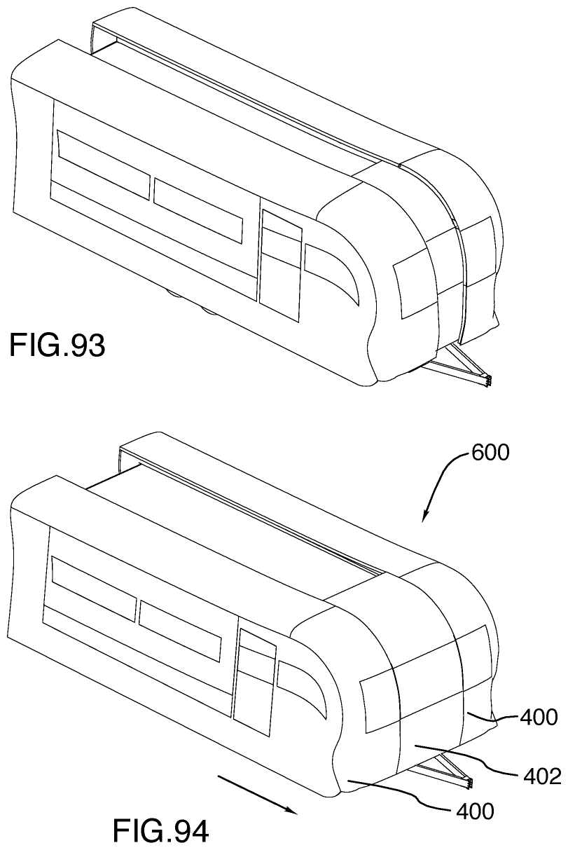

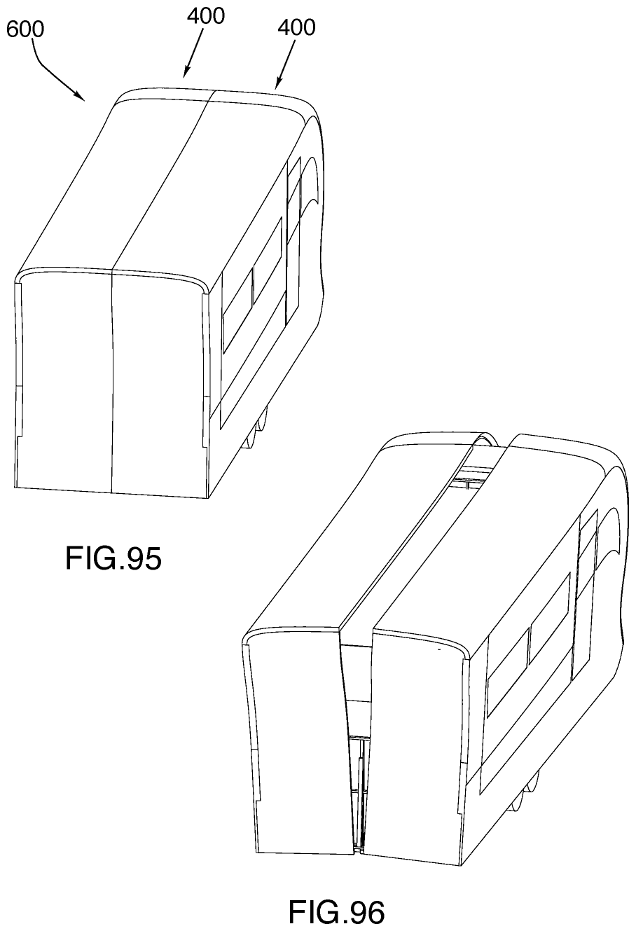

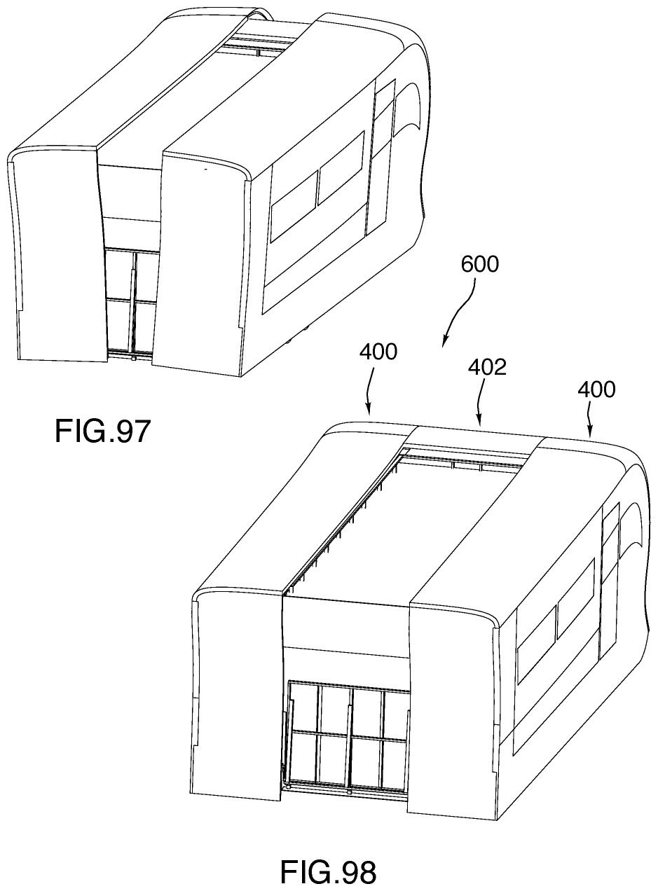

FIGS. 91-98 show another embodiment 600 of the invention which differs from that shown in FIGS. 77-86 in that it is the shells, rather than the nose wall of the body, that have longitudinal movement.

More specifically, the shells move rearwardly relative to the body during movement from the collapsed position to the expanded position such that the nose walls 400 of the shells are contiguous when the shells are in the collapsed position, as shown in FIGS. 91-94, and the nose wall 402 of the body is contiguous with the nose wall of each shell when the shells are in the expanded position.

Persons of ordinary skill will readily appreciate that the aforementioned functionality can be achieved by creating a suitably-shaped track and track follower system.

### Variations

Whereas the illustrated tracks are angular, it will be appreciated that the tracks could be contoured.

Whereas a pair of bearings is shown, it will be appreciate that a longer or heavier apparatus might employ additional bearings.

Whereas the chassis illustrated is a trailer frame, it will be appreciated that the chassis could be a motorhome frame and could have more or fewer axles. The chassis could have no axles at all and simply be suited for road transport, such as in the manner of a container.

Whereas reference is made to a dwelling, i.e. a place of residence, it will be understood that the invention has much broader utility. Temporary shelter or storage and mobile offices or clinics are just a few examples.

Whereas electric actuators are specified, hydraulic cylinders or other similar mechanisms could be used.

Whereas a specific arrangement of motions is described in relation to the separation of the shells, it will be appreciated that this could be modified to achieve similar end purposes, to wit, the desired double-wide, flat-floor outcome.

Whereas a specific drive mechanism and inclinator are shown and described, it will be appreciated that other mechanical assemblies could be utilized.

Further, whereas a bi-fold ramp is utilized to provide ground egress, a telescopic rail system could be employed, such that a single ramp could reach the ground.

As well, whereas in the drawings, the bi-fold ramp traverses to the roof while fully extended, the free end of the bi-fold ramp could be orientated upwardly, to form a safety wall, and chains, bars or flanking walls could be employed, to better ensure the safety of a passenger on the lift.

Further, whereas the roof deck illustrated in generally barren of fixtures, fold out chairs and other structures could be provided, such as those shown in US2002125736.

Whereas an accelerometer is used for determining level, other sensors could be employed.

Whereas a pressure sensor and encoders are used to determine the lift available at each leg (jack), other mechanisms are possible, for example, radar distance sensors could be placed adjacent each jack. In this case, the computing facility would not need to assume a planar surface coincident with the design base of the wheels and could utilize actual elevations for the initial suitability calculation.

Whereas the levelling system is shown in use with a single axle trailer such that the pivot axis is defined by the pivot axis of the wheels, persons of ordinary skill in the art can readily ascertain the pivot axis of a dual axis trailer by placing the trailer on a level surface and raising the trailer on its tongue jack.

Whereas a specific example of the hinged transition surfaces is shown it will be appreciated that the method could be utilized to accommodate the placement of other volumes in the core (or in the shell).

As well, whereas a floor is shown, it will be appreciated that the method could be employed also for walls.

Yet further variations are possible. Accordingly, the invention should be understood to be limited only by the accompanying claims, purposively construed.

1. An apparatus for use with a chassis adapted for road transport, the apparatus comprising
a body connected in use to the chassis, the body defining a floor and a ceiling disposed in stacked spaced relation to one another, the floor being disposed above the chassis and horizontal; and
a pair of shells, each shell comprising:
a floor and a ceiling disposed in stacked spaced relation to one another; and
a wall from which the floor and ceiling protrude,
the shells being mounted for movement between:
a collapsed position, wherein the shells are relatively proximal to one another, the walls are disposed in flanking relation to the body, the ceilings of the shells overly the ceiling of the body and the floors of the shells overly the floor of the body; and
an expanded position, wherein the shells are relatively distal to one another, the ceilings of the shells define extensions of the ceiling of the body and the floors of the shells define extensions of the floor of the body.

2. The apparatus of claim 1, wherein the chassis is selected from motorhome chassis and trailer chassis.

3. The apparatus of claim 1, wherein in the expanded position, the floors of the shells are horizontal and coplanar with the floor of the body.

4. (canceled)

5. The apparatus of claim 1, wherein in the collapsed position, the floors of the shells are horizontal and abut.

6. The apparatus of claim 1, wherein the ceiling of the body is horizontal.

7. The apparatus of claim 1, wherein the walls are vertical in both the extended and collapsed positions.

8. The apparatus of claim 1, wherein the shells are mounted for movement between the collapsed and the expanded position by a bearing arrangement.

9. The apparatus of claim 8, wherein the bearing arrangement comprises a pair of bearings for each shell, the bearings of the pair being spaced apart from one another lengthwise of the
dwelling and each comprising:
a track fixedly mounted to the chassis;
a roller rotatably mounted to the chassis;
a roller disposed in the track of the chassis to be guided thereby for movement and rotatably mounted to the shell by means of a lever arm; and
a track fixedly mounted to the shell and in receipt of the roller of the chassis for guided movement thereof,
the tracks and rollers being configured such that: as the shells initially separate from the collapsed position, their inner edges lift and outer edges drop; as the shells reach the expanded configuration, their inner edges drop and outer edges lift; as the shells initially move from the expanded configuration towards the collapsed configuration, their inner edges lift and outer edges drop; and as the shells reach the collapsed configuration, their inner edges drop and outer edges lift.

10. The apparatus of claim 1, wherein the body further comprises
a roof that is horizontal when the body is level; and
a wall that is perpendicular to the roof and extends from the floor to the roof, the wall of the body being perpendicular to the walls of the shells.

11. (canceled)

12. The apparatus of claim 1, further comprising:
a carriage mounted in use to the wall for reciprocating movement between a raised position adjacent the roof and a lowered position distal to the roof, the raised position being spaced from the lowered position along an axis which is substantially vertical when the dwelling is level; and
a platform pivotally mounted to the carriage for movement between a raised position, whereat the platform is substantially parallel to the wall, and a lowered position, whereat, when the dwelling is level, the platform is level.

13. The apparatus according to claim 12, whereat the platform is further pivotable to a loading position, whereat the platform extends downwardly from the carriage when the dwelling is level.

14. (canceled)

15. The apparatus according to claim 12, wherein the platform has a surface which is substantially coplanar and contiguous with the roof when at the raised position.

16. The apparatus of claim 10, further comprising
a carriage mounted in use to the wall for reciprocating movement between a raised position adjacent the roof and a lowered position distal to the roof, the raised position being spaced from the lowered position along an axis which is substantially vertical when the dwelling is level; and
a platform pivotally mounted to the carriage for movement between a raised position, whereat the platform is substantially parallel to the wall, and a lowered position, whereat, when the dwelling is level, the platform is level,
wherein
the shells are movable between the collapsed position and the expanded position only when the platform is at the raised position and beneath the roof; and
when the shells are in the collapsed position, the platform is at the raised position, beneath the roof and disposed between the wall and the shells.

17. An apparatus for use with a wheel-mounted dwelling having a floor and a design bottom, the design bottom being defined by the flattened surface of the wheels when the wheel-mounted dwelling is on a horizontal surface, the apparatus comprising:
a level coupled in use to the dwelling;
a plurality of extendable legs, each leg having a known stroke, the plurality of legs being connected in use to the dwelling in supporting relation and at known positions relative to the dwelling;
a sensor arrangement for determining the lift available at each leg;
a computing facility adapted to calculate, utilizing the sensor arrangement, the levels, the position of the legs relative to the dwelling and the position of the dwelling relative to the wheels, whether the legs have sufficient lift to level and stabilize the dwelling; and
an actuator adapted to extend the legs to level and stabilize the dwelling when the legs have sufficient lift available.

18. The apparatus according to claim 17, wherein the computing facility is adapted to generate one or both of: (i) an indication that the legs have sufficient lift to level and stabilize the vehicle; and (ii) an indication that the legs do not have sufficient lift to level and stabilize the vehicle.

19. The apparatus according to claim 17, wherein the computing facility is adapted to generate one or more of:
(i) an indication that the legs have sufficient lift to level and stabilize the vehicle;
(ii) an indication that the legs do not have sufficient lift to level and stabilize the vehicle; and
(iii) an indication as to any blocking required beneath the legs to render the legs suitable to lift and stabilize the vehicle.

20. The apparatus according to claim 17, wherein the sensor arrangement comprises a pressure sensor at each leg.

21. The apparatus according to claim 17, wherein the computing facility is adapted calculate, utilizing the level, the position of the legs relative to the dwelling and the position of the dwelling relative to the wheels, whether the legs would have sufficient lift to level and stabilize the dwelling assuming that the ground beneath the dwelling is a planar surface parallel to the floor and coincident with the design bottom of the wheels.

22-24. (canceled)

25. A dwelling for use with a chassis adapted for road transport, the apparatus comprising
a body connected in use to the chassis, the body defining a floor and a ceiling disposed in stacked spaced relation to one another, the floor being disposed above the chassis and horizontal; and
a shell comprising:
a floor and a ceiling disposed in stacked spaced relation to one another; and
a wall from which the floor and ceiling protrude,
the shell being mounted for movement between:
a collapsed position, wherein the wall is disposed in flanking relation to the body, the ceiling of the shell overlies the ceiling of the body and the floor of the shell overlies the floor of the body; and
an expanded position, wherein the wall is relatively distal to the body, the ceiling of the shell defines an extension of the ceiling of the body and the floor of the shell defines an extension of the floor of the body and is coplanar therewith,
the floor of one or more of the shell and the body being shaped such that, in the expanded position of the shell, an aperture is defined, the aperture being spanned by a pair of coplanar panels, each hinged to the other panel and to a respective one of the floor of the shell and the floor of the body.

26-27. (canceled)

28. The dwelling of claim 1, wherein the shells move rearwardly relative to the body during movement from the collapsed position to the expanded position.

29-30. (canceled)
